(19) United States
(12) Patent Application Publication
(10) Pub. No.: US 2018/0285247 A1
(43) Pub. Date: Oct. 4, 2018

(54) SYSTEMS, METHODS, AND APPARATUS FOR AUTOMATED CODE TESTING

(71) Applicant: The Travelers Indemnity Company, Hartford, CT (US)

(72) Inventors: Nehal B. Gandhi, South Windsor, CT (US); Daniel R. Finch, Wethersfield, CT (US); Tyler S. Singkofer, St. Paul, MN (US); Patrick T. Graziosi, Glastonbury, CT (US)

(21) Appl. No.: 15/472,825

(22) Filed: Mar. 29, 2017

(51) Int. Cl. G06F 11/36; G06F 9/445

(52) U.S. Cl. CPC G06F 11/3668; G06F 8/60

(57) ABSTRACT

Systems, apparatus, methods, and articles of manufacture provide for managing code deployment. In one example implementation, after packaging application code, a code deployment system defines a first container and a second container for a container-as-a-service (CaaS) service, based on the application code package. The example system then uses the CaaS service to automatically conduct a first container test of the first container, and, in parallel, to automatically conduct a second container test of the second container.

### FIELD OF THE INVENTION

The present invention relates generally to systems for maintaining applications and other software, and more particularly to improvements in systems for software testing.

### BACKGROUND OF THE INVENTION

Prior art systems are known for facilitating software development in enterprise environments, including for coordinating the testing of new applications and revised applications as part of the development cycle. Such systems, however, are generally not optimized for parallel testing of software, nor do they allow for the testing of software in different environments concurrently or within a short time frame. Such systems typically are limited to the availability of human teams and/or development environments, and may require significant manual involvement at various points and human decision-making. Also, such systems cannot be easily or efficiently scaled to accommodate larger development teams or the concurrent development and testing of large numbers of code projects. Prior art systems further may rely on scheduled build periods (e.g., weekly builds) and/or the manual execution of acceptance testing, regression testing, and/or performance testing. The drawbacks of these prior art systems lead to delays, slower development cycles, inefficient use of computing resources, and nonproductive waiting time for software developers and quality assurance professionals.

### SUMMARY OF THE INVENTION

According to some embodiments of the present invention, systems, methods, apparatus, articles of manufacture, and/or computer readable media (e.g., a non-transitory computer readable memory storing instructions for directing a processor of a code development controller device) provide a process for automated testing of software in multiple testing processes (e.g., in parallel in accordance with the respective characteristics of multiple environments). In some embodiments, the process for deployment and/or testing of software comprises the following steps:
a) receiving application code associated with an application development project;
b) packaging the application code to create an application code package;
c) defining a first container for a container-as-a-service (CaaS) service based on the application code package;
d) defining a second container for the CaaS service based on the application code package;
e) automatically conducting, using the CaaS service, a first container test of the first container; and
f) in parallel with conducting the first container test of the first container, automatically conducting, using the CaaS service, a second container test of the second container.

According to some embodiments of the present invention, systems, methods, apparatus, articles of manufacture, and/or computer readable media (e.g., a non-transitory computer readable memory storing instructions for directing a processor of a code development controller device) provide a process for automated testing of software in multiple testing processes (e.g., in parallel in accordance with respective characteristics of multiple environments). In some embodiments, the process for deployment and/or testing of software comprises the following steps:

a) receiving, by a controller device executing a container-as-a-service (CaaS) to control application testing and deployment processes, application code associated with an application development project, the application code defining one or more application units of the application code package for testing;
b) storing the application code in a database;
c) packaging the application code to create an application code package;
d) unit testing each of the one or more defined application units;
e) debugging the application code package using a static code analysis process;
f) defining a first container for the CaaS service based on the application code package;
g) defining a second container for the CaaS service based on the application code package;
h) automatically conducting, using the CaaS service, a first container test of the first container;
i) in parallel with conducting the first container test of the first container, automatically conducting, using the CaaS service, a second container test of the second container;
j) determining a first result of the first container test of the first container;
k) determine a second result of the second container test of the second container; and automatically selecting and performing, based on the first result and the second result, one of: (i) automatically promoting the application code package to an application deployment process, and (ii) automatically transmitting a signal including an indication of a failure of the application code package in at least one of the first container test and the second container test.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a block diagram of a system according to one or more embodiments;

FIG. 2 is a block diagram of a system according to one or more embodiments;

FIG. 3 is a flowchart of a method according to one or more embodiments;

FIG. 4 is a flowchart of a method according to one or more embodiments; and

FIG. 5 is a diagram of a system according to one or more embodiments.

### DETAILED DESCRIPTION

In accordance with one or more embodiments described in this disclosure, some or all steps of a software development life cycle may be improved by automation and/or parallel execution of testing processes to test a code project. In some embodiments, one or more testing functions that are part of a software development process for a code project may be executed automatically in one or more testing environments using a CaaS service. In some embodiments, two or more testing processes may be executed using a CaaS service to perform the testing of a code project in parallel and/or concurrently.

In some embodiments, an application or other code project may be migrated from a first code environment, such as a software development environment, to one or more different target code environments. As will be understood by those skilled in the art, a software development process may include one or more tests of code for an application. In accordance with one or more embodiments described in this disclosure, a software application may be developed in a software development environment, and then migrated to and tested in one or more different code testing environments. In one example, an application may be migrated from a development environment to at least one code testing environment (e.g., of a series of code testing environments, or of a plurality of parallel code testing environments). In another example, an application may be migrated from one code testing environment to at least one other code testing environment (e.g., in a series or sequence of code testing environments). In another code development example, an application may be migrated from one or more code testing environments (e.g., after validating and accepting new or updated source code) to a production code environment.

The inventors have recognized that distributed development and maintenance of a plurality of applications and other types of code projects provide unique challenges during the development process, testing of software, and integration of tested software into production environments, and that there is a need for code development processes, and code testing processes in particular, that limit the amount of human intervention required to validate and accept code for production use and/or that accelerate the rate of code testing by using different code testing environments in parallel and/or concurrently (e.g., using a CaaS service). In some implementations, feedback on any build, regression, and/or performance issues may be received in a matter of minutes after updated code is checked in to the code development system.

According to some embodiments of the present invention, a code development architecture and/or code validation process address issues associated with development and/or maintenance of software applications. Applicants have recognized that problems related to development and testing of software may be addressed by the use of at least one CaaS service. According to some embodiments, implementation may comprise automated, parallel code testing processes to verify that application code conforms to code development standards, acceptance testing standards, regression testing standards, and/or performance testing standards.

“CaaS” and “CaaS service,” as those terms are used in this disclosure, refer to computer services (e.g., cloud-based computer services) configured for the management of containers. Examples of CaaS services include the Docker™ software containerization platform by Docker Inc. and VMware VApp. The container-based virtualization or “containerization” provided by CaaS allows an application (or multiple instances of the same application) to be packaged, along with its respective dependencies (e.g., any computer resources that are required or need to be available in case they are called for when the application is executed), as a portable container. Accordingly, the container may be isolated from others on a shared operating system, and may be executed in any environment (physical or virtual) supported by the container service.

In accordance with some embodiments, the code development architecture and/or code certification process allows for efficient scaling by reducing the requirement for human interaction. Software development professionals (e.g., code developers and quality assurance (QA) team members) are able to move developed and validated code to the next desired environment with no dependency on other personnel, manual methods, or manual processes. As a result, steps in prior art systems that cause delays and idle time for development and QA resources may be avoided.

According to some embodiments, a software application for controlling end-to-end code development is sequenced programmatically and interfaces with one or more repositories storing a plurality of test cases (e.g., HP Quality Center), one or more repositories storing test execution results, one or more repositories for storing and managing operation data about data systems and applications (e.g., Enterprise Meta>Environment™ by Ab Initio), one or more application content databases (e.g., Teradata Database™ by Teradata Corporation, SharePoint™ by Microsoft Corporation) and one or more application project management databases (e.g., Project and Portfolio Management™ (PPM) by Hewlett Packard Enterprise (HPE)).

It will be understood by those skilled in the art that a code development life cycle may include a number of different stages, including build, analysis, testing, and deployment. According to some embodiments, code development in a build phase may include the use of tools, such as build automation tools (e.g., Maven™) for pulling in required computer resources, source code management tools and version control repositories (e.g., Github™), and containerization platforms (e.g., Docker). Build automation is the process of automating the creation of a software build and the associated processes including compiling computer source code into binary code and packaging binary code. Version control (also known as revision control or source control) is a component of software configuration management, and refers to the management of changes to documents, computer programs, large web sites, and other collections of information.

Code analysis may include, for example, code analysis tools such as a unit-testing framework for the Java™ programming language (e.g., JUnit), acceptance testing tools such as Cucumber, static Java-based source code analyzers (e.g., PMD), and Java code coverage analysis tools (e.g., Cobertura, Clover™). “Unit testing,” as the term is used in this disclosure, refers to a testing method for testing individual units of source code. The scope of the individual unit may vary from coding project to coding project, but in general the unit will be the smallest testable portion of a given application or other software project. For example, in one case the smallest testable portion may be a specific function or called procedure. In other circumstances, the testable unit may be an interface, a specific object, or a specific class. “Static analysis,” also called “static code analysis,” is a method of computer program debugging that is done by examination of the code without executing the program. The process provides an understanding of the code structure, and can help to ensure that the code adheres to industry standards.

Testing tools that may be useful, in accordance with some embodiments, for testing code for production may include tools for smoke testing (e.g., SOAP UI), a software-testing framework for web applications (e.g., Selenium™) for regression testing, and load-testing and/or performance-testing tools, such as Apache JMeter™ by Apache Software Foundation. Regression testing is the process of testing changes to computer programs to make sure that the older programming still works with the new changes. Regression testing, particularly in larger companies, typically is performed by code testing specialists. Acceptance testing is a level of the software testing where a system is tested for acceptability. The purpose of this test is to evaluate the system's compliance with the business requirements and assess whether it is acceptable for delivery. Performance testing, in general, is a testing practice performed to determine how a system performs in terms of responsiveness and stability under a particular workload. It can also serve to investigate, measure, validate, or verify other quality attributes of the system, such as scalability, reliability, and resource usage.

The following example scenario describes one example implementation of a software development life cycle in accordance with one or more embodiments of the present invention. Although the example scenario describes the building, testing, and deployment of a web application programmed using the Java programming language, the example scenario is not intended to be limited to any embodiment of the present invention. The scenario may be modified to accommodate any of various types of programming languages and development tools that may be useful in providing for automated parallel testing of code containers for a code project.

According to the example scenario, a developer develops a Java application using an integrated development environment (IDE), such as the Eclipse™ IDE for Java, and performs local testing on the coded application. In order to provide for version control, the developer checks-in the code changes into a source code repository (e.g., a Github source repository). A software development automation server (e.g., continuous integration automation tool Jenkins™) is triggered automatically by the check-in of the changes to start the build process. Alternatively, the build process may be scheduled or may be specifically requested (e.g., manually by the developer). If required, the automation server and/or another build automation tool (e.g., Maven) checks out any dependent components from a repository and builds the application. In an initial code analysis testing phase, the software development automation server initiates at least one unit test (e.g., using JUnit), initiates static code analysis of the changes (e.g., using PMD), and/or initiates an analysis of code coverage (e.g., using Cobetura).

Following the completion of the initial code analysis testing phase, the software development automation server preferably generates a report of the results of the unit test and/or one or more code analyses. In one example, the automation server transmits an indication of performance of the checked-in changes in the initial code analysis testing phase (e.g., pass or fail). In one example, the report may provide a comparison of a performance or characteristic of the changes relative to a success standard (e.g., a predetermined success standard).

The software development automation server, according to the example scenario, next determines whether to promote the changes for automated testing using a CaaS service. In some embodiments, a comparison to a success standard may be used to determine whether to promote the changes from one environment to another and/or whether to begin a subsequent testing process. (e.g., an automated container instance for testing). For instance, before moving the changes to container testing, the automation server in the example scenario may require that all unit tests are passed, the static code analysis determined at least an 80% pass rate, and the code coverage analysis determined at least an 80% pass rate.

If the software development automation server verifies that any criteria for promoting the changes are met, then one or more containers are created for automated testing. Otherwise, any defects or issues with the code (e.g., as determined by the initial code analysis testing phase) are logged (e.g., in a code status database). Issues may be assigned back to the developer for resolution.

A containerization platform providing a CaaS service is used by the automation server for automated testing. According to the example scenario, three separate instances are initiated for automated testing in parallel: a first instance for smoke and regression testing, a second instance for performance testing, and a third instance for acceptance testing. In one example, the containerization platform executes SOAP UI for smoke testing and Selenium for regression testing; executes JMeter for performance testing; and executes Cucumber for acceptance testing. If any defects are identified during the container-based automated testing (e.g., in comparison to test success criteria), the issues are logged and assigned to one or more developers to fix. If, on the other hand, the changes passed all container-based automated testing, then the changes are promoted by the automation server for deployment via a platform-as-a-service (PaaS) service. Finally, according to the example scenario, the PaaS runs the application (e.g., on a cloud platform).

In some embodiments, a code development architecture may be coded with intelligence to make decisions concerning whether to promote changes or new applications based on, for example, test case execution, number of open defects, and/or adherence of code to pre-defined standards. In one embodiment, a code development process addresses these issues as an automated packaging of code, transmittal of code from one environment repository to another, testing of code, and/or checking of the migrating code into a new code environment (e.g., a production environment).

According to one example implementation, a code development process with a code testing feature may comprise a software tool developed with a set of UNIX® scripts that reduce resource overhead by eliminating the need for human involvement and decision-making and by promoting code between environments within very short time periods (e.g., a fraction of a second). According to the example implementation, UNIX scripts may be written for a code development platform such as the Co>Operating System enterprise business application environment by Ab Initio Software LLC, and may have the ability to interact with multiple technologies. For instance, a set of tables may be created in an application content database (e.g., a Teradata Database™) to record information about every step of a software development process (e.g., for reporting purposes).

According to yet another example implementation, a code testing of code from a test environment to a production environment may begin with a check to determine whether the code is eligible for automated code testing. For instance, a user may request or initiate a code testing process using a user interface (e.g., by actuating a button or other user-selectable interface object, or typing in a command). The user enters or selects the name of the code project to be tested for defects and to be validated for production, or includes the name in the request. In response to receiving the request, a code development controller device accesses a database of code projects.

Various embodiments described in this disclosure provide for one or more types of improvements to the systems conventionally used in the software arts for managing the maintenance and development of software products, such as applications and other coding projects. Some embodiments advantageously eliminate wait times, migration delays, and interruptions, with low or no human intervention. One or more embodiments provide advantageously for an increased number of test cycles that may be executed in a testing environment as a result of time saved in code deployment to the testing environment. Some embodiments provide advantageously for the elimination of duplicate code packaging and technical repository creation, reducing resource allocation costs and redundant process steps.

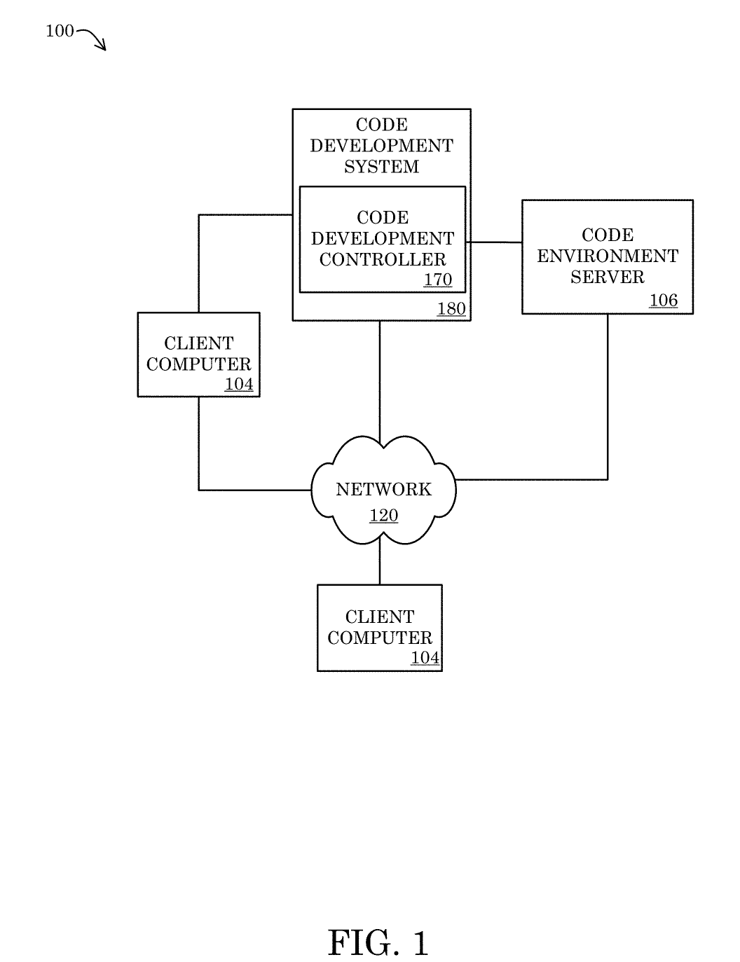

FIG. 1 depicts a block diagram of an example system 100 for software development, according to some embodiments. Although reference may be made in this disclosure to examples of web applications and/or enterprise applications, it will be readily understood that disclosed embodiments may be useful with respect to various types of applications.

The system 100 may comprise one or more client computers 104 in communication with a code development system 180 via a network 120. A code development controller 170 is integrated into the code development system 180, for example, as an embedded module, a portal, or other functionality accessible through and/or by the code development system 180. In one embodiment, information stored by the code development system 180 may be provided advantageously to the code development controller 170 for code development processing. For example, stored information about an application in development (e.g., source code, current status, eligibility for automated code testing) may be provided to or otherwise accessible by the code development controller 170 without requiring manual input (e.g., from a user).

In some embodiments, the code development system 180 may be hosted by a controller or server computer (e.g., a computer specially programmed to provide for one or more of the functions described in this disclosure). Typically a processor (e.g., one or more microprocessors, one or more microcontrollers, one or more digital signal processors) of a client computer 104 or a server computer will receive instructions (e.g., from a memory device or like device), and execute those instructions, thereby performing one or more processes defined by those instructions. Instructions may be embodied in, for example, one or more computer programs and/or one or more scripts.

In some embodiments the code development system 180 and/or one or more of the client computers 104 stores and/or has access to data useful for facilitating code development workflows. According to some embodiments, any or all of such data may be stored by or provided via one or more code environment servers 106 of system 100. A code environment server 106 may comprise, for example, an external computing system, a virtual computing environment, or a remote computer system for storing and serving data, such as test scheme data (e.g., for use in conducting one or more testing scenarios), or a combination of such remote and local data devices.

In some embodiments, the code development system 180 may store some or all of the program instructions, and a client computer 104, such as a computer workstation or terminal of a user (e.g., a code developer or quality assurance (QA) professional), may execute the application remotely via the network 120, and/or download from the code development system 180 (e.g., a web server) some or all of the program code for executing one or more of the various functions described in this disclosure. In some embodiments, a client computer 104 is used to execute an application, stored locally on the client computer 104, that accesses information stored on, or provided via, the code development system 180, code environment server 106, one or more other client computers 104, and/or network 120.

In one embodiment, a server computer may not be necessary or desirable. For example, some embodiments described in this disclosure may be practiced on one or more devices without a central authority. In such an embodiment, any functions described in this disclosure as performed by a server computer and/or data described as stored on a server computer may instead be performed by or stored on one or more such devices. Additional ways of distributing information and program instructions among one or more client computers 104 and/or server computers will be readily understood by one skilled in the art upon contemplation of the present disclosure.

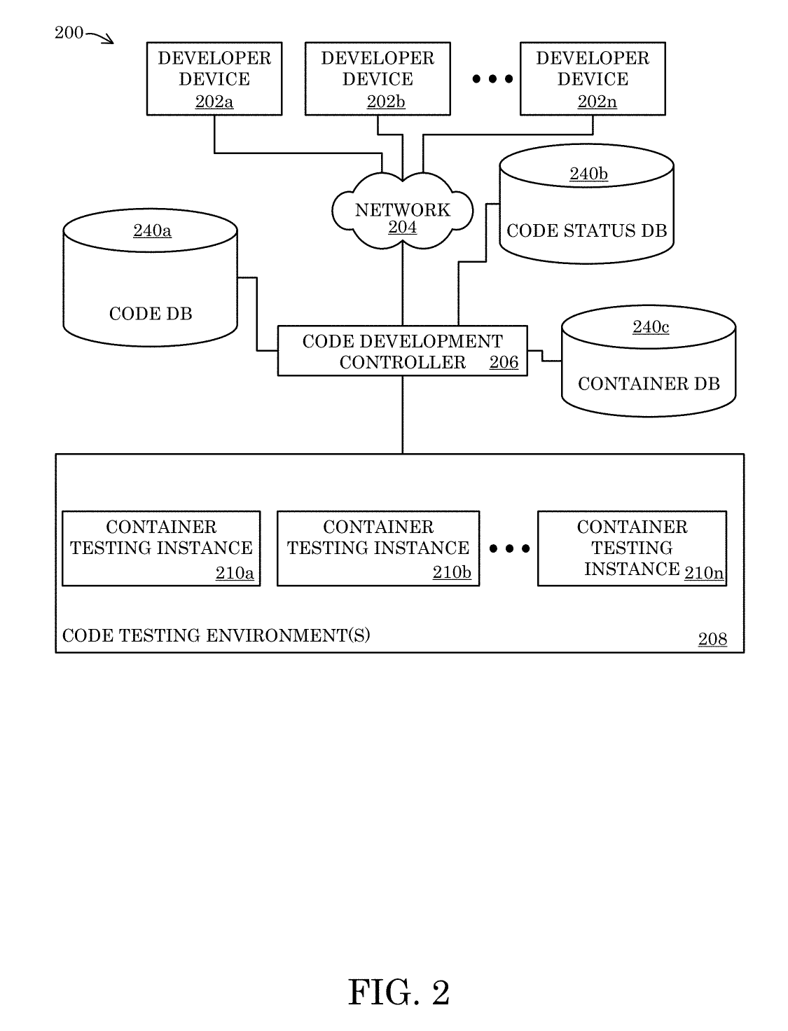

Referring now to FIG. 2, a block diagram of a system 200 according to some embodiments is shown. In some embodiments, the system 200 may comprise a code development platform. In some embodiments, the system 200 may comprise a plurality of developer devices 202a-n, networks 204, and/or a code development controller 206.

In accordance with some embodiments, one or more code testing environments 208 may be defined by a plurality of container testing instances 210a-n. For example, each container testing instance may be created using a containerization platform (e.g., Docker) for use in conducting one or more specific types of tests. As discussed in this disclosure, each container instance provides a portable container packaging an application and computer resource dependencies, and may be configured for execution in one or more operating systems. As also discussed in this disclosure, the container testing instances may be created automatically to execute one or more types of tests, and may be used to conduct automated testing in parallel.

As depicted in FIG. 2, any or all of the various components 202a-n, 204, 206, and 210a-n may be in communication with and/or coupled to one or more databases 240a-c. The system 200 may comprise, for example, a code database (DB) 240a, a code status DB 240b, and/or a container DB 240c.

According to some embodiments, any or all of the components 202a-n, 204, 206, 210a-n, and 240a-c of the system 200 may be similar in configuration and/or functionality to any similarly named and/or numbered components described in this disclosure. Fewer or more components 202a-n, 204, 206, 210a-n, and 240a-c (and/or portions thereof) and/or various configurations of the components 202a-n, 204, 206, 210a-n, and 240a-c may be included in the system 200 without deviating from the scope of embodiments described in this disclosure. While multiple instances of some components are depicted, and while single instances of other components are depicted, for example, any component 202a-n, 204, 206, 210a-n, and 240a-c depicted in the system 200 may comprise a single device, a combination of devices and/or components 202a-n, 204, 206, 210a-n, and 240a-c, and/or a plurality of devices, as is or becomes desirable and/or practicable. Similarly, in some embodiments, one or more of the various components 202a-n, 204, 206, 210a-n, and 240a-c may not be needed and/or desired in the system 200.

According to some embodiments, the developer devices 202a-n may be utilized by code development professionals to access (e.g., via the network 204 and/or one or more other networks not explicitly shown) functionality provided by code development controller 206, various types of data provided by databases 240a-c, and/or container testing instances 210a-n.

The container testing instances 210a-n may, for example, provide application dependencies, and/or provide characteristics of one or more various environments with respective purposes, such as testing and/or production. In some embodiments, more than one container testing instance may be implemented for the same purpose (e.g., two container testing instances for regression testing) and/or for more than one purpose (e.g., for combined regression resting and performance testing).

According to some embodiments, communications between the developer devices 202a-n and the container testing instances 210a-n, the code testing environment(s) 208 and container testing instances 210a-n, and/or the databases 240a-c may be managed and/or facilitated by the code development controller 206. The code development controller 206 may, for example, receive commands and other types of communications from developer devices 202a-n and, in response, initiate a code development management process with an automated code testing feature using container instances.

In some embodiments, the code development controller 206 may be in communication with the code DB 240a. According to some embodiments, the code DB 240a may comprise a dynamically-scalable database service (e.g., the DynamoDB™ service provided by Amazon® Web Services, LLC). Some embodiments provide for receiving and/or storing source code (e.g., by a code development controller 206) and/or packaging source code for migration from one environment to another, and storing the code package in a repository. In some embodiments, the code development controller 206 may be in communication with the code DB 240a for receiving and/or storing source code and/or code packages associated with a code project.

In some embodiments, the code development controller 206 may be in communication with the code status DB 240b. According to some embodiments, the code status DB 240b may comprise a dynamically-scalable database service. The code status DB 240b may, for example, store information specific to the status of a code project with respect to a code development management process. For example, one or more records may be stored in the code status DB 240b in association with a particular application or other code project, with each record providing information about the past and/or current status of the migration of the code project from one environment to another and/or with respect to automated code analysis testing (e.g., static code analysis) and/or automated container-based code testing (e.g., regression and performance testing executed in parallel using multiple containers). During a code development process (as described with respect to various embodiments in this disclosure) executed by the code development controller 206, the code development controller 206 may store information about successes and/or failures in the code development of one or more code projects, including code projects migrated using a code testing feature. The code development controller 206 may further use stored information about code project statuses to coordinate report generation and/or assignment of developers to resolve any issues (e.g., defects identified during code analysis testing and/or automated container-based testing).

As discussed in this disclosure, some embodiments provide for testing code associated with a project (e.g., automatically under the control of the code development controller 206), and creating portable containers including computer resources. In some embodiments, the code development controller 206 may be in communication with the container DB 240c. According to some embodiments, the container DB 240c may comprise a dynamically-scalable database service. The container DB 240c may, for example, comprise a data store of environment and/or application data suitable for testing and/or debugging.

According to some embodiments, any or all of the developer devices 202a-n in conjunction with one or more of the container testing instances 210a-n and/or the databases 240a-c (e.g., via the network 204) may conduct (in whole or in part), facilitate, and/or otherwise be associated with execution of one or more stored procedures, applications, processes, and/or methods (and/or one or more portions and/or combinations thereof) as described in this disclosure.

According to some embodiments, processes described in this disclosure may be performed and/or implemented by and/or otherwise associated with one or more specialized and/or computerized processing devices, specialized computers, computer terminals, computer servers, computer systems and/or networks, and/or any combinations thereof (e.g., by one or more application developers and/or developer devices). In some embodiments, methods may be embodied in, facilitated by, and/or otherwise associated with various input mechanisms and/or interfaces.

Any processes described in this disclosure do not necessarily imply a fixed order to any depicted actions, steps, and/or procedures, and embodiments may generally be performed in any order that is practicable unless otherwise and specifically noted. Any of the processes and/or methods described in this disclosure may be performed and/or facilitated by hardware, software (including microcode), firmware, or any combination thereof. For example, a storage medium (e.g., a hard disk, universal serial bus (USB) mass storage device, and/or digital video disk (DVD)) may store thereon instructions that when executed by a machine (such as a computerized processing device) result in performance according to any one or more of the embodiments described in this disclosure.

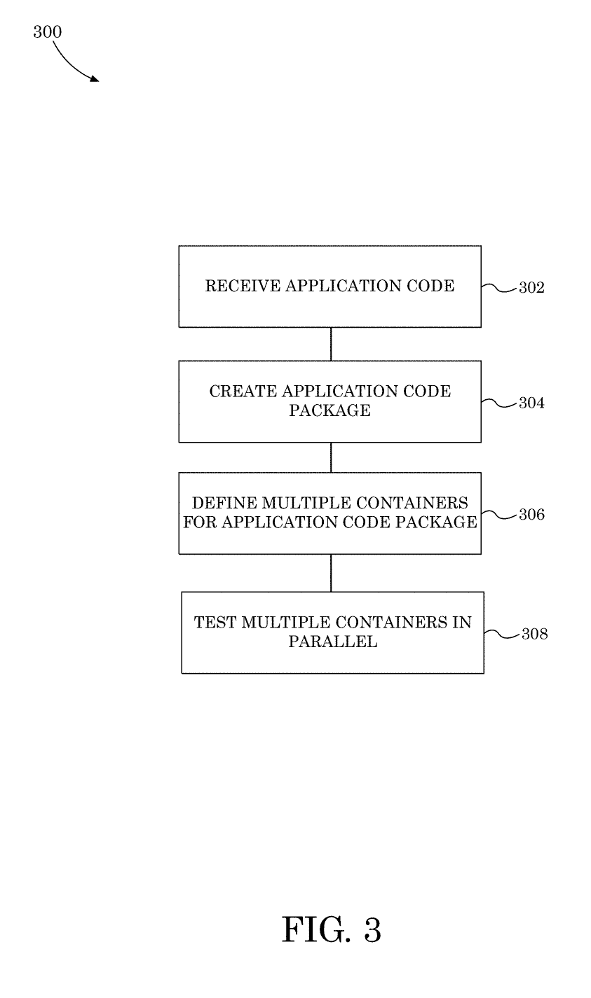

Referring now to FIG. 3, a flow diagram of a method 300 according to some embodiments is shown. The method 300 may be performed, for example, by a code development controller device (e.g., of a code development system). According to some embodiments, the method 300 may comprise receiving application code (e.g., source code for a web-based application), at 302. The method 300 may further comprise creating an application code package, at 304, such as by initiating a process to migrate a code project (e.g., for a new application or changes to an existing application) from one environment to another. In some embodiments, creating the application code package may be executed automatically (e.g., in accordance with a migration schedule and/or in response to a trigger event such as the check-in of coding changes to a repository).

The method 300 may further comprise defining multiple containers for the application code package, at 306, and testing the multiple containers parallel, at 308. In one embodiment, defining multiple containers may comprise creating multiple container instances for testing purposes, as discussed above with respect to FIG. 2 and to the example scenario. In one example, if code changes pass an initial code analysis testing phase (e.g., unit testing and/or static code analysis), then a software development automation server or other type of code development controller may automatically initiate a containerization platform (e.g., Docker) to create a plurality of container instances for executing one or more respective tests (e.g., regression tests, performance tests, and/or smoke tests). Defining the multiple containers may comprise first determining whether the source code is eligible for automated testing using a CaaS (e.g., by determining whether the code project was predetermined to be eligible, such as by looking up a stored database record associated with the code project). Testing the multiple containers in parallel may comprise running separate container instances concurrently (or substantially at the same time) in order to conduct one or more particular tests in each respective instance. In one example, a first instance may be used for a first type of testing, and a second instance may be used for a second type of testing. The two types may be the same or different, and more than one type of test may be executed for any given instance. In some embodiments, a report may be generated following the testing, and a professional may be assigned to resolve any defects identified.

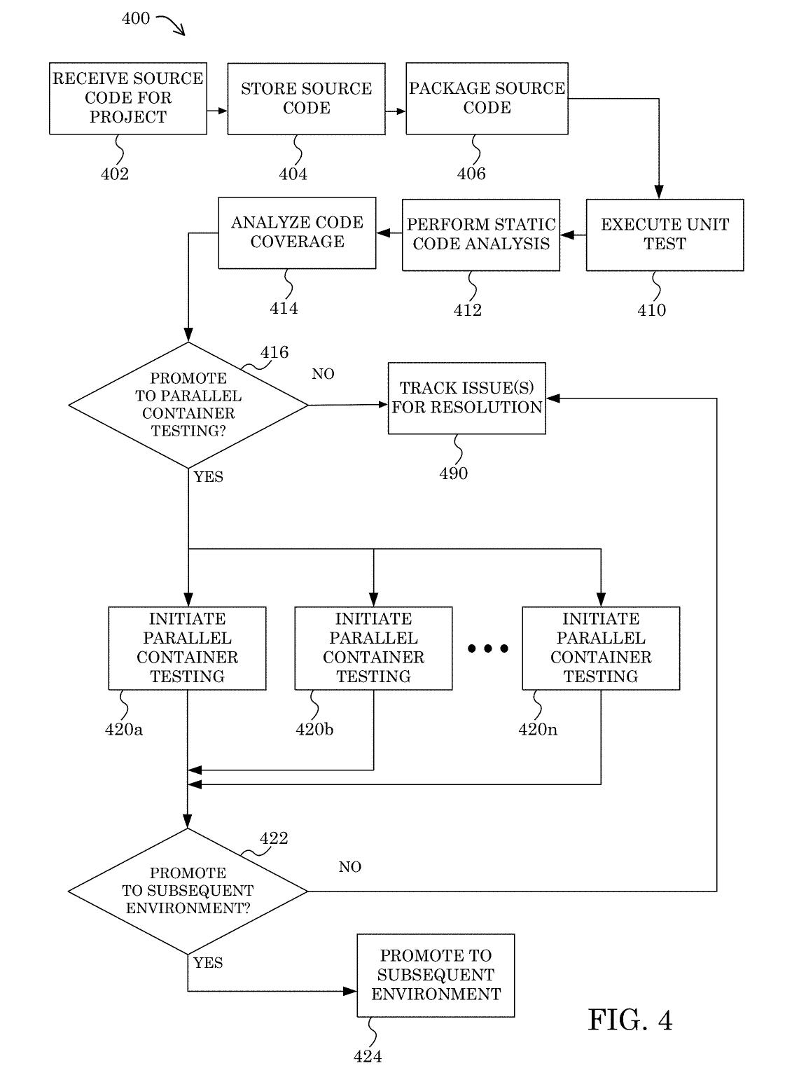

Referring now to FIG. 4, a flow diagram of a method 400 according to some embodiments is shown. The method 400 may be performed, for example, by a code development controller device (e.g., a software development automation server of a code development system).

According to some embodiments, the method 400 may comprise a build phase that includes receiving source code for a code project, at 402, storing the source code, at 404, and packaging the source code, at 406. In some embodiments, the source code may include at least one defined unit of code (e.g., defined for unit testing). The method 400 may further comprise executing a unit test, at 410 (e.g., running a unit test on at least one unit of code defined in the source code). The method 400 may further comprise performing static code analysis, at 412, and analyzing code coverage, at 414.

The method 400 may further comprise determining whether to promote the code project to parallel container testing, at 416. If not, any issues that may have been identified in unit testing (410), static code analysis (412), and/or code coverage analysis (414) may be stored or otherwise tracked for resolution, at 490. For example, a developer may be assigned one or more issues to resolve before resubmitting the source code to a build phase.

The decision to promote the code project to parallel container testing may be based, for example, on the evaluation of the code during unit testing (410), static code analysis (412), and/or code coverage analysis (414). For example, certain success criteria may be defined for each type analysis, with promotion being contingent upon the code meeting those success criteria. In some embodiments, different success criteria may be dynamically determined for different applications and/or predetermined for different applications (e.g., and stored for accessing during run-time execution). If it is determined (e.g., by a code development controller) to advance the code to automated parallel container testing, then a plurality of instances of parallel container testing are initiated, at 420a-n. As discussed in this disclosure, a code development controller may be configured to access a CaaS service and/or initiate a containerization platform to create multiple container instances, each configured for a predetermined testing purpose (e.g., regression testing, acceptance testing, and/or performance testing). The portable containers, which contain any required resource dependencies, may be executed automatically and in parallel, advantageously reducing total testing time and the need for human intervention to manage and/or initiate testing.

The method 400 may further comprise determining whether to promote the code to the subsequent environment (e.g., quality assurance environment, production environment), at 422, and, if so, promoting the code to one or more subsequent environments, at 424. If the automated parallel testing indicates any defect when executing one or more of the testing instances, then the development process may track the issue(s) for resolution, at 490.

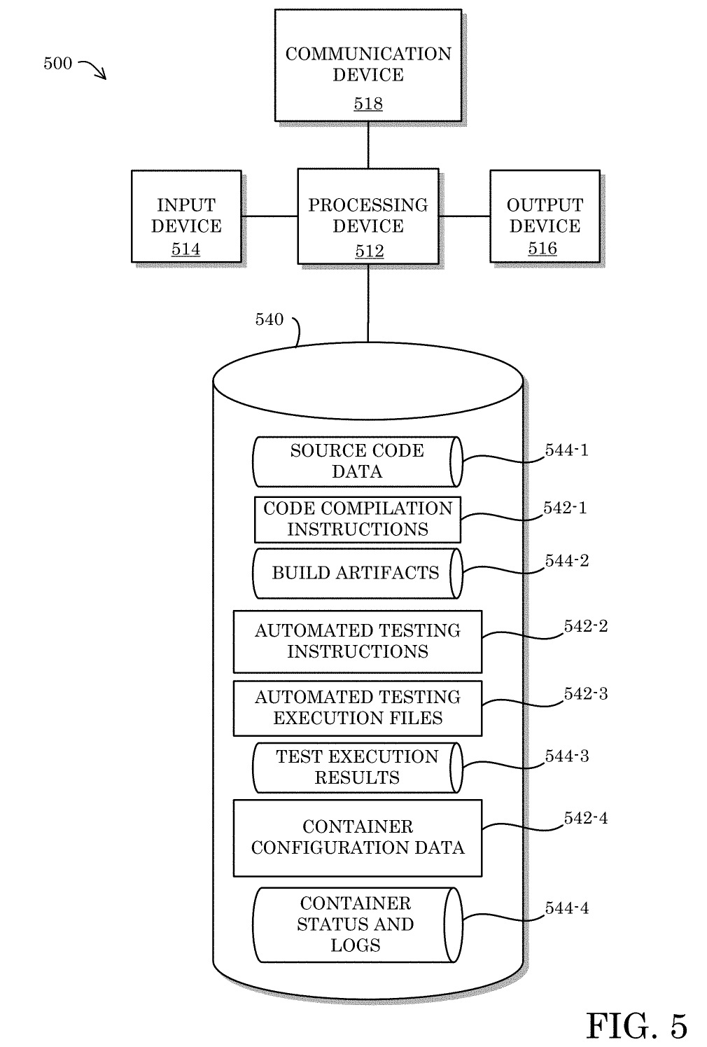

Turning to FIG. 5, a block diagram of an apparatus 500 according to some embodiments is shown. In some embodiments, the apparatus 500 may be similar in configuration and/or functionality to any of the code environment server 106, code development controller 170, code development controller 206, and/or may otherwise comprise a portion of the systems 100 and 200 described in this disclosure. The apparatus 500 may, for example, execute, process, facilitate, and/or otherwise be associated with one or more methods (e.g., code development processes involving automated container-based testing) described in this disclosure.

In some embodiments, the apparatus 500 may comprise a processing device 512, an input device 514, an output device 516, a communication device 518, and/or a memory device 540. Fewer or more components 512, 514, 516, 518, 540 and/or various configurations of the components 512, 514, 516, 518, 540 may be included in the apparatus 500 without deviating from the scope of embodiments described in this disclosure.

According to some embodiments, the processing device 512 may be or include any type, quantity, and/or configuration of electronic and/or computerized processor that is or becomes known. The processing device 512 may comprise, for example, an Intel® IXP 2800 network processor or an Intel® XEON™ Processor coupled with an Intel® E7501 chipset. In some embodiments, the processing device 512 may comprise multiple inter-connected processors, microprocessors, and/or micro-engines. According to some embodiments, the processing device 512 (and/or the apparatus 500 and/or portions thereof) may be supplied power via a power supply (not shown) such as a battery, an alternating current (AC) source, a direct current (DC) source, an AC/DC adapter, solar cells, and/or an inertial generator. In the case that the apparatus 500 comprises a server such as a blade server, necessary power may be supplied via a standard AC outlet, power strip, surge protector, and/or uninterruptible power supply (UPS) device.

In some embodiments, the input device 514 and/or the output device 516 are communicatively coupled to the processing device 512 (e.g., via wired and/or wireless connections and/or pathways) and they may generally comprise any types or configurations of input and output components and/or devices that are or become known, respectively. The input device 514 may comprise, for example, a keyboard that allows an operator of the apparatus 500 to interface with the apparatus 500 (e.g., by a developer, such as to initiate a code development process by uploading revised source code). The output device 516 may, according to some embodiments, comprise a display screen and/or other practicable output component and/or device. The output device 516 may, for example, provide a code development interface to a developer (e.g., for transmitting testing reports). According to some embodiments, the input device 514 and/or the output device 516 may comprise and/or be embodied in a single device such as a touch-screen monitor.

In some embodiments, the communication device 518 may comprise any type or configuration of communication device that is or becomes known or practicable. The communication device 518 may, for example, comprise a network interface card (NIC), a telephonic device, a cellular network device, a router, a hub, a modem, and/or a communications port or cable. In some embodiments, the communication device 518 may be coupled to provide data to a developer device and/or a user device (not shown in FIG. 5), such as in the case that the apparatus 500 is configured to provide a code development process with automated parallel testing for code maintenance as described this disclosure. In some embodiments, the communication device 518 may comprise an IR, RF, Bluetooth™, and/or Wi-Fi® network device coupled to facilitate communications between the processing device 512 and another device (such as a developer device and/or a user device).

According to the example embodiment for a specialized controller device depicted in FIG. 5, the memory device 540 may comprise any appropriate information storage device that is or becomes known or available, including, but not limited to, units and/or combinations of magnetic storage devices (e.g., a hard disk drive), optical storage devices, and/or semiconductor memory devices such as RAM devices, read only memory (ROM) devices, single data rate random access memory (SDR-RAM), double data rate random access memory (DDR-RAM), and/or programmable read only memory (PROM).

The memory device 540 may, according to some embodiments, store one or more of code compilation instructions 542-1, automated testing instructions 542-2, automated testing execution files 542-3, and/or container configuration data 542-4. In some embodiments, the code compilation instructions 542-1, automated testing instructions 542-2, automated testing execution files 542-3, and/or container configuration data 542-4 may be utilized by the processing device 512 to provide output information via the output device 516 and/or the communication device 518.

According to some embodiments, code compilation instructions 542-1 may be operable to cause the processing device 512 to compile source code data 544-1 for one or more code projects. The source code data 544-1 (e.g., source code defining one or more applications or other code projects) may, for example, be analyzed, parsed, scored, checked for compliance, and/or otherwise processed by the processing device 512, in accordance with the code compilation instructions 542-1. According to some embodiments, the code compilation instructions 542-1 comprise compiler instructions for compiling source code as part of a code development process.

Compiling the source code generates build artifacts or other types of computer-executable software instructions necessary to run a particular application (e.g., web application, enterprise application, or other types of applications). Generated build artifacts may be stored, for example, in build artifacts 544-2 of memory device 540, and accessed as necessary (e.g., by a code development controller) for running an application for testing or consumption by an end user.

In some embodiments, the memory device 540 may further comprise, and/or apparatus 500 may have access to, automated testing instructions 542-2 and automated testing execution files 542-3. In one embodiment, automated testing execution files 542-3 comprise tools for running one or more tests on build artifacts 544-2 in accordance with automated testing instructions 542-2. For example, automated testing instructions 542-2 may direct processing device 512 to use PMD (or other source code analyzer) for static code analysis and/or Junit (or other unit testing framework) for unit testing stored in automated testing execution files 542-3 to review one or more of the build artifacts 544-2. In some embodiments, the automated testing instructions 542-2 and/or the automated testing execution files 542-3 may be configured to create files, such as test execution results 544-3, for storing information about the results of testing build artifacts. In one example, test execution results may comprise a corresponding record for each type of automated testing execution file executed during testing in association with an indication of any success, failure, or measure of performance of the build artifact during the test(s).

In some embodiments, the memory device 540 may further comprise, and/or apparatus 500 may have access to, code development testing standards for determining whether a code project should be promoted (e.g., after a code analysis testing phase using static code analysis and/or unit testing and/or after automated parallel testing using a CaaS). The testing standards may be used, in accordance with some embodiments, for comparing with information stored in the test execution results 544-3. In some embodiments, test execution results 544-3 may include an indication of whether a build artifact met a testing standard.

In some embodiments, the memory device 540 may further comprise, and/or apparatus 500 may have access to, container configuration data 542-4 and container status and logs 544-4. As described with respect to various embodiments in this disclosure, a plurality of containers may be used for testing build artifacts in parallel. In one embodiment, container configuration data 542-4 comprises configuration data used to setup one or more containers for a given code project and to run the execution files created during a build process (e.g., build artifacts compiled from source code data 544-1 using code compilation instructions 542-1, and stored in build artifacts 544-2).

In some embodiments, automated testing instructions 542-2 comprises instructions for initiating automated container-based testing in parallel using container configuration data 542-4. Such instructions may comprise, in one or more embodiments, instructions for determining whether to promote a particular build artifact to automated container-based testing in parallel (e.g., based on test execution results 544-3). Container status and logs 544-4 may comprise information about the configuration of a particular container and/or information about results of testing of the container. In one embodiment, automated testing instructions 542-2 comprises instructions for determining, based on information in the container status and logs 544-4 for a particular code project, whether to promote the tested build artifact for the code project to the next environment (e.g., to quality assurance and/or to production).

In one or more embodiments, data and/or instructions may be received by the apparatus 500, for example, via the input device 514 and/or the communication device 518 (e.g., from a developer, developer device, a user, and/or user device in a development, test, pre-production, or production environment).

Any or all of the specialized instructions and data types described this disclosure and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 500. According to some embodiments, the memory device 540 may be incorporated into and/or otherwise coupled to the apparatus 500 (e.g., as shown) or may simply be accessible to the apparatus 500 (e.g., externally located and/or situated).

One or more of various types of data storage devices may be used in accordance with one or more embodiments discussed in this disclosure. A data storage device may, for example, be utilized to store instructions and/or data, such as the instructions and/or data described in reference to one or more of the example computing devices in this disclosure. One or more types and/or combinations of data storage devices may generally store program instructions, code, and/or modules that, when executed by a processing device, cause a particular machine to function in accordance with one or more embodiments described in this disclosure. In some embodiments, instructions stored on a data storage device may, when executed by a processor (such as a processor device described in this disclosure with respect to one or more computing devices), cause the implementation of and/or facilitate the any of the methods, and/or portions or combinations of such methods, described in this disclosure. The following descriptions of some example types of data storage devices are representative of a class and/or subset of computer-readable media that are defined in this disclosure as “computer-readable memory” (e.g., non-transitory memory devices, as opposed to transmission devices or media).

According to some embodiments, a data storage device may comprise one or more various types of internal and/or external hard drives. The data storage device may, for example, comprise a data storage medium that is read, interrogated, and/or otherwise communicatively coupled to and/or via a disk reading device. In some embodiments, the data storage device and/or the data storage medium may be configured to store information utilizing one or more magnetic, inductive, and/or optical means (e.g., magnetic, inductive, and/or optical-encoding). The data storage medium may comprise one or more of a polymer layer, a magnetic data storage layer, a non-magnetic layer, a magnetic base layer, a contact layer, and/or a substrate layer. According to some embodiments, a magnetic read head may be coupled and/or disposed to read data from the magnetic data storage layer.

In some embodiments, a data storage medium may comprise a plurality of data points disposed with the data storage medium. The data points may, in some embodiments, be read and/or otherwise interfaced with via a laser-enabled read head disposed and/or coupled to direct a laser beam through the data storage medium.

In some embodiments, a data storage device may comprise a CD, CD-ROM, DVD, Blu-Ray™ Disc, and/or other type of optically-encoded disk and/or other storage medium that is or becomes known or practicable. In some embodiments, a data storage device may comprise a USB keyfob, dongle, and/or other type of flash memory data storage device that is or becomes known or practicable. In some embodiments, a data storage device may comprise RAM of any type, quantity, and/or configuration that is or becomes practicable and/or desirable. In some embodiments, a data storage device may comprise an off-chip cache such as a Level 2 (L2) cache memory device. According to some embodiments, a data storage device may comprise an on-chip memory device such as a Level 1 (L1) cache memory device.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable in this disclosure.

In some embodiments, one or more specialized machines such as a computerized processing device, a server, a remote terminal, and/or a user device may implement the various practices described in this disclosure.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “in this disclosure” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described in this disclosure, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described in this disclosure (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used in this disclosure is an area that conveys information to a viewer. The information may be dynamic, in which case, an LCD, LED, organic LED (OLED), CRT, digital light processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p, 4 k, or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch-screen features or associated keypads as is well understood.

The present disclosure may refer to a “control system”. A control system, as that term is used in this disclosure, may be a computer processor coupled with an operating system, device drivers, and appropriate programs (collectively “software”) with instructions to provide the functionality described for the control system. The software is stored in an associated memory device (sometimes referred to as a computer readable medium).

A “processor” means any one or more microprocessors, central processing unit (CPU) devices, computing devices, microcontrollers, digital signal processors, or like devices.

As used in this disclosure, the term “network component” may refer to a user or network device, or a component, piece, portion, or combination of user or network devices. Examples of network components may include a static random access memory (SRAM) device or module, a network processor, and a network communication path, connection, port, or cable.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described in this disclosure may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented in this disclosure are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described in this disclosure. Further, despite any depiction of the databases as tables, other formats (including relational databases, object-based models, hierarchical electronic file structures, and/or distributed databases) could be used to store and manipulate the data types described in this disclosure. Likewise, object methods or behaviors of a database can be used to implement various processes, such as those described in this disclosure. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used in this disclosure, the term “network component” may refer to a user or network device, or a component, piece, portion, or combination of user or network devices. Examples of network components may include a Static Random Access Memory (SRAM) device or module, a network processor, and a network communication path, connection, port, or cable.

As used in this disclosure, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described in this disclosure are associated with an “indication”. As used in this disclosure, the term “indication” may be used to refer to any indicia and/or other information indicative of or associated with a subject, item, entity, and/or other object and/or idea. As used in this disclosure, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

In addition, some embodiments are associated with a “network” or a “communication network”. As used in this disclosure, the terms “network” and “communication network” may be used interchangeably and may refer to an environment w in this disclosure one or more computing devices may communicate with one another, and/or to any object, entity, component, device, and/or any combination thereof that permits, facilitates, and/or otherwise contributes to or is associated with the transmission of messages, packets, signals, and/or other forms of information between and/or within one or more network devices. Such devices may communicate directly or indirectly, via a wired or wireless medium such as the Internet, LAN, WAN or Ethernet (or IEEE 802.3), Token Ring, or via any appropriate communications means or combination of communications means. In some embodiments, a network may include one or more wired and/or wireless networks operated in accordance with any communication standard or protocol that is or becomes known or practicable. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), the Fast Ethernet LAN transmission standard 802.3-2002® published by the Institute of Electrical and Electronics Engineers (IEEE), or the like. Networks may be or include a plurality of interconnected network devices. In some embodiments, networks may be hard-wired, wireless, virtual, neural, and/or any other configuration of type that is or becomes known. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

It will be readily apparent that the various methods and algorithms described in this disclosure may be implemented by, e.g., specially programmed computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

What is claimed is:

1. A controller device for application testing and deployment comprising:
a processor; and
a computer-readable medium storing instructions that when executed by the processor direct the processor to:
receive application code associated with an application development project, the application code defining one or more application units for testing;
store the application code;
package the application code to create an application code package;
unit test each of the one or more defined application units;
define a first container for a container-as-a-service (CaaS) service based on the application code package;
define a second container for the CaaS service based on the application code package;
automatically conduct a first container test of the first container;
in parallel with conducting the first container test of the first container, automatically conduct a second container test of the second container;
determine a first result of the first container test of the first container;
determine a second result of the second container test of the second container; and
automatically select and perform, based on the first result and the second result, one of:
(a) automatically promote the application code package to an application deployment process,
and
(b) automatically transmit a signal including an indication of a failure of the application code package in at least one of the first container test and the second container test.

2. The controller device of claim 1, wherein the first container test comprises a regression test and the second container test comprises one or more of the following:
a smoke test,
a performance test, and
an acceptance test.

3. The controller device of claim 1, wherein the first container test comprises a performance test and the second container test comprises one or more of the following:
a smoke test, and
an acceptance test.

4. The controller device of claim 1, wherein the first container test comprises an acceptance test and the second container test comprises a smoke test.

5. The controller device of claim 1, wherein the application deployment process comprises:
transmitting the application code package to an end-user testing environment.

6. The controller device of claim 1, wherein the application deployment process comprises:
transmitting the application code package to a production environment.

7. The controller device of claim 1, wherein the instructions when executed by the processor further direct the processor to:
debug the application code package using a static code analysis process.

8. The controller device of claim 1, wherein the instructions when executed by the processor further direct the processor to:
determine, using a code coverage analysis process, an amount of code covered by the unit testing.

9. The controller device of claim 1, wherein automatically promoting the application code package to an application deployment process comprises:
determining, based on the first result and the second result, that there were no failures in the first container test or the second container test.

10. The controller device of claim 1, wherein automatically selecting and performing, based on the first result and the second result, comprises:
determining a first review standard for the first container test;
determining a second review standard for the second container test;
comparing the first review standard to the first result; and
comparing the second review standard for the second result.

11. The controller device of claim 1, wherein automatically transmitting the signal including an indication of a failure of the application code package in at least one of the first container test and the second container test comprises:
creating a message including the indication of the failure;
determining at least one developer associated with the application code package; and
transmitting the message to the at least one developer.

12. The controller device of claim 1, wherein automatically transmitting the signal including an indication of a failure of the application code package in at least one of the first container test and the second container test comprises:
creating a record in a defect tracking database, the record including the indication of the failure in association with the application code package.

13. The controller device of claim 1, wherein defining the first container based on the application code package comprises:
registering the first container with a container registry of the CaaS service.

14. A method for application testing and deployment, the method comprising:
receiving, by a controller device controlling application testing and deployment processes, application code associated with an application development project, the application code defining one or more application units for testing,
wherein the controller device is configured to execute a container-as-a-service (CaaS) service;
storing, by the controller device, the application code in a database;
packaging, by the controller device, the application code to create an application code package;
unit testing, by the controller device, each of the one or more defined application units;
defining, by the controller device, a first container for the CaaS service based on the application code package;
defining, by the controller device, a second container for the CaaS service based on the application code package;
automatically conducting, by the controller device using the CaaS service, a first container test of the first container;
in parallel with conducting the first container test of the first container, automatically conducting, by the controller device using the CaaS service, a second container test of the second container;
determining, by the controller device, a first result of the first container test of the first container;
determining, by the controller device, a second result of the second container test of the second container; and
automatically selecting and performing, by the controller device based on the first result and the second result, one of:
(a) automatically promoting the application code package to an application deployment process,
and
(b) automatically transmitting a signal including an indication of a failure of the application code package in at least one of the first container test and the second container test.

15. The method of claim 14, wherein the first container test comprises a regression test and the second container test comprises one or more of the following:
a smoke test,
a performance test, and
an acceptance test.

16. The method of claim 14, wherein the first container test comprises a performance test and the second container test comprises one or more of the following:
a smoke test, and
an acceptance test.

17. The method of claim 14, wherein the first container test comprises an acceptance test and the second container test comprises a smoke test.

18. The method of claim 14, wherein the application deployment process comprises:
transmitting the application code package to an end-user testing environment.

19. The method of claim 14, wherein the application deployment process comprises:
transmitting the application code package to a production environment.

20. The method of claim 14, further comprising:
debugging, by the controller device, the application code package using a static code analysis process.

21. The method of claim 14, further comprising:
determining, using a code coverage analysis process, an amount of code covered by the unit testing.

22. The method of claim 14, wherein automatically promoting the application code package to an application deployment process comprises:
determining, based on the first result and the second result, that there were no failures in the first container test or the second container test.

23. The method of claim 14, wherein automatically selecting and performing, based on the first result and the second result, comprises:
determining a first review standard for the first container test;
determining a second review standard for the second container test;
comparing the first review standard to the first result; and
comparing the second review standard for the second result.

24. The method of claim 14, wherein automatically transmitting the signal including an indication of a failure of the application code package in at least one of the first container test and the second container test comprises:
creating a message including the indication of the failure;
determining at least one developer associated with the application code package; and
transmitting the message to the at least one developer.

25. The method of claim 14, wherein automatically transmitting the signal including an indication of a failure of the application code package in at least one of the first container test and the second container test comprises:
creating a record in a defect tracking database, the record including the indication of the failure in association with the application code package.

26. The method of claim 14, wherein defining the first container based on the application code package comprises:
registering the first container with a container registry of the CaaS service.
